(19) United States
(12) Patent Application Publication
(10) Pub. No.: US 2009/0025317 A1
(43) Pub. Date: Jan. 29, 2009

(54) Arrangement for closing building openings in a water tight manner

(76) Inventors: Christian H. Wirz, Muenchen (DE); Udo Brabender, Globig (DE)

Correspondence Address: JORDAN AND HAMBURG LLP, 122 EAST 42ND STREET, SUITE 4000, NEW YORK, NY, 10168, US

(21) Appl. No.: 11/918,579

(22) PCT Filed: Nov. 11, 2006
(86) PCT No.: PCT/DE2006/001982

§ 371 Date: Oct. 29, 2007

(30) Foreign Application Priority Data
Dec. 16, 2005 (DE) 10 2005 060 759.4

(51) Int. Cl. E06B 9/02

(52) U.S. Cl. 52/202

(57) ABSTRACT

The invention relates to an arrangement for closing building openings in a watertight manner, wherein a frame is arranged at right angles on a watertight, stable covering panel, all the way round the latter and at a constant spacing from a wall of the building opening, and at least one pressure hose with an openable and closable pressure-hose connection is arranged all the way round the frame, and a periphery of the covering panel that projects beyond the building opening has, on the building side, an all-round sealing element and at least one swing-away handle is arranged on the outside of the covering panel, and projecting parts of the building opening are surrounded by the periphery of the covering panel such that the periphery of the covering panel, with the all-round sealing element, encloses the building opening in a watertight manner.

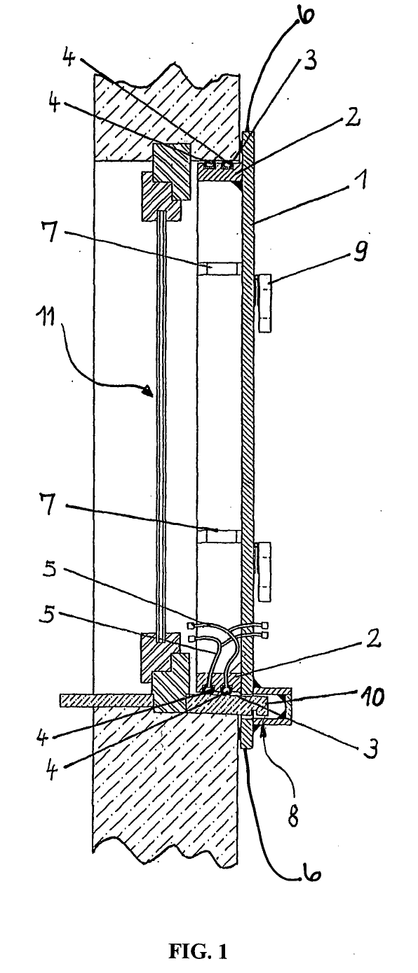

The invention relates to an arrangement for closing building openings in a water-tight manner.

DE 197 35 373 A1 discloses an arrangement for closing building openings, such as doors and windows, against the ingress of water. The arrangement comprises an inflatable cushion, of which the cross-sectional surface area in the inflated state is at least equal to the cross-sectional surface area of the building opening, so that the cushion butts in a sealed manner against the building opening from the inside. A serious disadvantage of this invention is that the cushion can easily be damaged by scum in the water and the ingress of water is thus not prevented. DE 299 11 264 U1 discloses a flood-protection arrangement, securing means which correspond with the openings in the masonry structure of the building which are to be closed off being fixed to the building. Profile bars of the securing means have rectilinear outer surfaces and curved inner surfaces, with circular curvature over ¾ of their extent. Furthermore, flange-like protrusions are provided on the adjacent outer surfaces, and these can be used to fasten the securing means in the masonry structure of the wall. A two-walled sealing bubble of cushion-like design has its peripheral regions engaging in the space enclosed by the curved inner surfaces, and it seals the opening in the masonry structure. The high technical outlay required for producing the protective arrangement is disadvantageous. Furthermore, there is also a risk here of the sealing bubble possibly being damaged by scum in the water and thus having its sealing properties adversely affected.

The object of the invention is to develop an arrangement which is intended for closing building openings in a water-tight manner and in the case of which the resistance to the ingress of water is increased and the technical outlay is reduced.

The object is achieved according to the invention in that a frame is arranged at right angles on a water-tight, stable covering panel, all the way round the latter and at a constant spacing from a wall of the building opening, the spacing between the frame and the wall being constant, and at least one pressure hose with an openable and closeable pressure-hose connection being arranged all the way round the frame, and a periphery of the covering panel, this periphery projecting beyond the building opening, has, on the building side, an all-round sealing element and at least one swing-away handle is arranged on the outside of the covering panel, and projecting parts of the building opening are surrounded by the periphery of the covering panel such that the periphery of the covering panel, with the all-round sealing element, encloses the building opening in a water-tight manner. Further embodiments of the invention are disclosed in subclaims 2-8.

The invention is explained in more detail hereinbelow with reference to an exemplary embodiment. The associated drawing shows a water-tight covering panel 1 for building openings which is stable in relation to water pressure and is intended for protecting the buildings against the ingress of water in the event of a flood. An all-round frame 2 is fitted at right angles on the covering panel 1. Building openings are constituted, in particular, by openings for windows and doors, which can be closed in a water-tight manner by the covering panel 1. The all-round frame 2 is at a constant spacing from a wall 3 of the respective building opening. Two pressure hoses 4 with an openable and closeable pressure-hose connection 5 are arranged in a water-tight manner on the wall side of the frame 2, all the way round the latter. For opening and closing the pressure-hose connection 5, use is made, for example, of a double nipple in the end of the pressure-hose connection 5. It is also possible to arrange just one pressure hose 4, or more than two pressure hoses 4, on the frame 2. The pressure-hose connections 5 may also be guided outward in a water-tight manner through the covering panel 1 or inward and outward through the covering panel 1. A part-periphery 6 of the covering panel 1, this part-periphery projecting beyond the building opening, has, on the building side, an all-round sealing element 7 and thus seals the covering panel 1, once placed in a position, in water-tight manner in relation to the building opening. Parts 8 which project from the building opening, for example a sill 10 of a window 11, are surrounded by the periphery 6 of the covering panel 1, the periphery 6 of the covering panel 1 ending up in planar abutment against the outside of the building and the all-round sealing element 7 sealing the building opening in a water-tight manner. For the purpose of handling the arrangement, the covering panel 1 has at least one swing-away handle 9 on the outside. Further handles 9 may be arranged inside or outside the covering panel 1. The covering panel 1 comprises a core made of foamed polypropylene (PP), a layer of aluminum with a layer made of pure polypropylene being fitted on either side of the core. It is also possible for the covering panel 1 to consist of HD polyethylene (PE).

The covering panel 1 is retained against the building opening from the outside, for example, by means of the handle 9, the sealing element 7 sealing the covering panel 1 in a water-tight manner in relation to the building. The pressure-hose connections 5 are connected to a media-supply means. The pressure hoses 4 expand by way of the media-supply means and clamp the covering panel 1 against the wall 3 of the building opening via the frame 2.

### LIST OF DESIGNATIONS

1 Covering panel
2 Frame
3 Wall
4 Pressure hose
5 Pressure-hose connections
6 Periphery
7 Sealing element
8 Parts
9 Handle
10 Window sill
11 Window

1. An arrangement for closing a building opening in a water-tight manner, comprising a frame arranged at right angles on a water-tight, stable covering panel, all the way round the latter and at a constant spacing from a wall of the building opening, the spacing between the frame and the wall being constant, and at least one pressure hose with an openable and closeable pressure-hose connection being arranged all the way round the frame and a periphery of the covering panel, said periphery projecting beyond the building opening, having, on the building side, an all-round sealing element and at least one swing-way handle is arranged on an outside of the covering panel, and projecting parts of the building opening are surrounded by the periphery of the covering panel such that the periphery of the covering panel, with the all-round sealing element, encloses the building opening in a water-tight manner.

2. The arrangement as claimed in claim 1, wherein the pressure-hose connections are guided in a water-tight manner through the covering panel.

3. The arrangement as claimed in claim 1, wherein the handle is fitted on the outside of the covering panel.

4. The arrangement as claimed in claim 1, wherein the handle is fitted on the inside of the covering panel.

5. The arrangement as claimed in claim 1, wherein a double nipple is arranged in the end of the pressure-hose connections.

6. The arrangement as claimed in claim 1, wherein the covering panel comprises a core made of foamed polypropylene, a layer of aluminum with a layer made of pure polypropylene being fitted on either side in each case.

7. The arrangement as claimed in claim 1, wherein the covering panel consists of high density polyethylene.

8. The arrangement as claimed in claim 1, wherein the pressure-hose connections are guided toward the inside and outside.
